(19) United States
(12) Patent Application Publication
(10) Pub. No.: US 2006/0202480 A1
(43) Pub. Date: Sep. 14, 2006

(54) Pipe clamp assembly with v-ring insert

(75) Inventors: Scott T. Cassel, Bloomfield Hills, MI (US); Brian T. Ignaczak, Rochester, MI (US); Michael E. Amedure, Rochester, MI (US); Kevin Kan Lee, Bloomfield Hills, MI (US)

Correspondence Address: JAMES D. STEVENS;REISING, ETHINGTON, BARNES, KISSELLE, P.C., P.O. BOX 4390, TROY, MI, 48099, US

(73) Assignee: Breeze-Torca Products, LLC, Auburn Hills, MI (US)

(21) Appl. No.: 11/368,886

(22) Filed: Mar. 6, 2006

Related U.S. Application Data
(60) Provisional application No. 60/594,027, filed on Mar. 4, 2005.

(51) Int. Cl. F16L 23/00

(52) U.S. Cl. 285/408

(57) ABSTRACT

A pipe clamp assembly that includes a v-band clamp and a v-ring. The v-band clamp includes a band that carries a T-bolt tightening mechanism and a v-insert. The v-insert has an inwardly facing concave surface that fits over radially projecting flanges on the ends of the pipes or other tubular bodies to be joined. The v-ring is formed from sheet metal and has a convex profile and fits between the flanges so that the flanges can be tightly compressed between the v-insert and v-ring during tightening of the clamp. The angle of the walls defining the convex profile of the v-ring can be greater than that of the v-insert so that the v-ring provides some outward springing force on the flanges during tightening of the clamp. The v-ring can have an indexing feature and one or more clips for pre-attachment. A method of making the v-ring is also provided.

### CROSS-REFERENCE TO RELATED APPLICATION

This application claims the priority of U.S. Provisional Application No. 60/594,027, filed Mar. 4, 2005, the complete disclosure of which is hereby incorporated by reference.

### TECHNICAL FIELD

This invention relates to pipe clamp assemblies and more particularly to v-band clamps used for joining pipes and other such tubular bodies.

### BACKGROUND OF THE INVENTION

Many industries use tubular bodies for transporting gases, liquids, or both, at various pressures. The automotive industry uses tubular bodies in many applications including in a vehicle exhaust system. Roundish exhaust pipes transport exhaust gas from a vehicle's engine and to the atmosphere. Along the way, the pipes are often segmented in several pieces so they can follow a mapped vehicle underbody path and so they can join exhaust system components such as catalytic converters, particulate filters, mufflers, and the like. Typically these pipe pieces are joined together at their ends with pipe clamps. The clamps should form a joint having an effective fluid seal against leakage and a high degree of pull-apart strength against road shock.

Of the pipe clamps used for the different joints in the exhaust system, band clamps are used for lap joints (overlapping, telescoping pipes), couplers are used for butt joints (abutting, end-to-end pipes), and v-band clamps are used for flanged pipe end (butt) joints. The v-band clamps (or simply, v-clamps) commonly have an outer sheet metal band that extends circumferentially from a first end to a second end, with a T-bolt fastening mechanism that draws the ends together for tightening of the clamp. Located on the inner surface of the band is a v-shaped concave insert (v-insert) that typically comprises several arc segments of concave cross-section that are roll-formed from an elongated piece of sheet metal, cut to size, and then welded to the outer band. Then, in use, the end flanges of the two pipes to be joined are located within the concave channel of this v-insert and the clamp tightened such that the flanges are captively retained in the v-insert. The v-clamp is sometimes used in conjunction with a v-ring that is positioned between the pipe end flanges to enhance the fluid seal. This v-ring provides support for the pipe end flanges so that the flanges are compressed between the v-insert and v-ring during tightening of the clamp. Gaskets are sometimes placed between the v-ring and pipe end flanges to improve the gas tightness of the seal. The v-rings are typically cast or machined to produce a stiff inner support component that does not deform appreciably during tightening of the clamp.

### SUMMARY OF THE INVENTION

The present invention provides a pipe clamp assembly that can be used for joining a pair tubular body ends such as pipe ends. The pipe clamp assembly includes a v-band clamp and a v-ring. The v-band clamp has a band with an inner surface, a tightening mechanism connected to the band to tighten and loosen the clamp, and a v-insert connected to the band's inner surface to receive flanges that are provided on the tubular body ends. The v-ring includes a convex profile that, during assembly of the pipes together, fits between the pipe end flanges and at least partially within the v-insert so that the flanges can be clamped against the v-ring during tightening of the clamp. In accordance with one aspect of the invention, the v-ring is made from sheet metal that is formed with the convex profile along its length and then the two opposite ends of the sheet metal are brought together and connected by a weld located along the axial length of the v-ring. In accordance with another aspect of the invention, the v-insert has a concave profile formed by a first pair of slanted annular walls and the v-ring has a convex profile formed by a second pair of slanted annular walls, wherein the first pair of walls form a first angle and the second pair of walls form a second angle that is greater than the first angle. Then, when the clamp is tightened, the v-insert applies pressure to the v-ring's annular walls via the joined tubular body flanges and this results in the wider annular walls of the v-ring deflecting towards each other such that the second angle decreases in measure towards that of the first angle. Gaskets can be provided if desired to further improve the gas-tightness of the joint.

In accordance with another aspect of the invention, the v-ring is provided with an indexing feature that allows the two tubular bodies to be rotationally aligned with each other during assembly of the clamp.

In accordance with another aspect of the invention, a pre-attachment clip is provided to connect the v-ring to one or both of tubular bodies and hold it in place while the v-band clamp is then attached.

In accordance with yet another aspect of the invention, the flanges used on the tubular bodies can be provided with a circumferential bead that eliminates the need for gaskets between the flanges and v-ring. The beads of the flanges are directly compressed against the annular walls of the v-ring during tightening of the clamp.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is an exploded view of a first embodiment of a pipe clamp assembly of this invention;

FIG. 2 shows a method of making the v-ring used in the pipe clamp assembly of FIG. 1;

FIG. 3 is a sectional view taken on line 3-3 of the v-ring of the pipe clamp assembly of FIG. 1;

FIG. 4 is a sectional view of the pipe clamp assembly of FIG. 1 showing it as installed on a pair of pipe ends;

FIG. 5 is an exploded view of salient portions of a second embodiment of a pipe clamp assembly of this invention;

FIG. 6 is a sectional view of portions of a third embodiment of a pipe clamp assembly of this invention;

FIG. 7 is an exploded view of portions of a fourth embodiment of a pipe clamp assembly of this invention;

FIG. 8 is a perspective view of a pipe end according to a fifth embodiment of a pipe clamp and tubular body end assembly of the present invention; and

FIG. 9 is a sectional view as in FIG. 4, but of the fifth embodiment to show the engagement of the pipe end flanges with the v-ring.

### DETAILED DESCRIPTION OF THE PREFERRED EMBODIMENTS

Referring now to the drawings, the invention will be described in several embodiments of a pipe clamp assembly adapted for joining a pair of tubular body ends. The invention will be described with specific reference to a v-band clamp and a v-ring used in a vehicle exhaust system. However, it will be appreciated as the description proceeds that the invention is useful in many different applications and may be implemented in many other embodiments. Furthermore, as used herein, the terms axially, angularly, slant, and radially refer to directions relative to the generally circular shape of the v-band clamp, so that the radial direction extends radially from the geometric center of the circular clamp, angularly refers to locations at points around the circumference of the clamp, the axial direction extends perpendicular from the radial plane of the clamp, and slanted refers to extending partially in both a radial and axial direction. Furthermore, the term “tubular body” encompasses bodies for transporting gases, liquids, or both, at various pressures including exhaust pipes, rolled pipes, cast pipes, bellow type tubings, as well as tubular housings such as are used on particulate filters and catalytic converters.

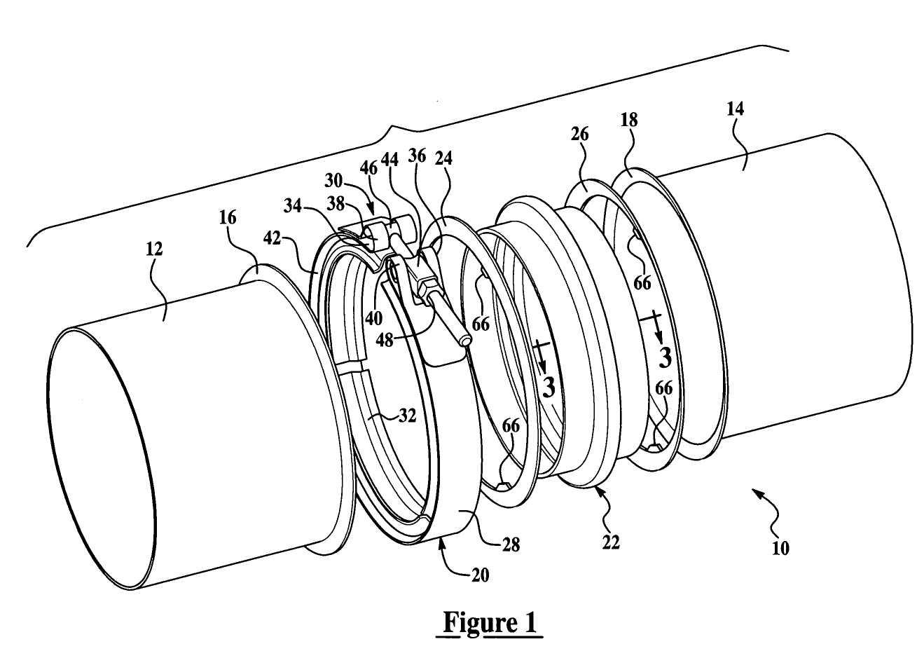

FIG. 1 shows a pipe clamp assembly 10 used to join a pair of tubular body ends, specifically a first pipe end 12 and a second pipe end 14 in a vehicle exhaust system. These pipes have a similar diameter and include a first radially projecting flange 16 and a second radially projecting flange 18. The flanges each slant away from their respective pipe end at an angle of about 70° with respect to the central axis of the pipe; this results in an angle of 40° between the two flanges when they are aligned with each other for assembly. The flanges 16,18 can be formed unitary with the pipes or can be separate components welded at or near the pipe edge. The flanges have a thickness similar to that of the pipe wall.

### First Embodiment

A first embodiment of the pipe clamp assembly 10 is shown in FIGS. 1-4. The pipe clamp assembly 10 fits over first and second pipe ends 12, 14 to form a joint having a fluid-tight seal and a high degree of pull-apart strength. The pipe clamp assembly includes a v-band clamp 20, a v-ring insert or v-ring 22, and a pair of gaskets 24, 26. These components are adapted for use with pipes having flanges 16, 18. The v-band clamp component 20 fits over both first and second pipe ends 12, 14, and when tightened, provides an evenly distributed radially inward force for sealing and strengthening the joint therebetween. V-band clamp 20 has an annular shape complementing the shape of first and second pipe ends 12, 14 and their flanges. It is made up of several parts including a band 28, a tightening mechanism 30, and a v-insert 32.

Band 28 constitutes the outer component of v-band clamp 20 and carries tightening mechanism 30 and v-insert 32. The band is made out of a suitable steel such as 301¼ hard stainless steel in a thickness of 2 mm. It is stamped out of sheet metal of this steel with a cutout at a first end 34 and at a second end 36. The stamped steel is then bent into a roundish shape by a suitable bending process leaving ends 34, 36 unattached and defining an inner surface 42. The ends are folded back on themselves and welded to provide a double layer of steel but leaving opposing loops 38, 40. While the loops are being formed, parts of tightening mechanism 30 are placed underneath the bight of each loop so that the folding and welding steps anchor the parts within the respective loop.

As noted, tightening mechanism 30 is connected to band 28 by loops 38, 40 and is used to draw first and second ends 34, 36 toward and away from each other to respectively tighten and loosen v-band clamp 20. When the ends are drawn toward each other, the tightening mechanism imparts the radially inward force provided by the v-band clamp. The particular tightening mechanism shown is of the T-bolt type, but other suitable tightening mechanisms can be used. The T-bolt mechanism 30 includes a trunnion 44, T-bolt 46, and nut 48, and the construction and operation of this T-bolt mechanism is known to those skilled in the art. Quick attach T-bolt tightening mechanisms that allow the T-bolt head to be easily attached to or separated from the first end 34 of the clamp can also be used.

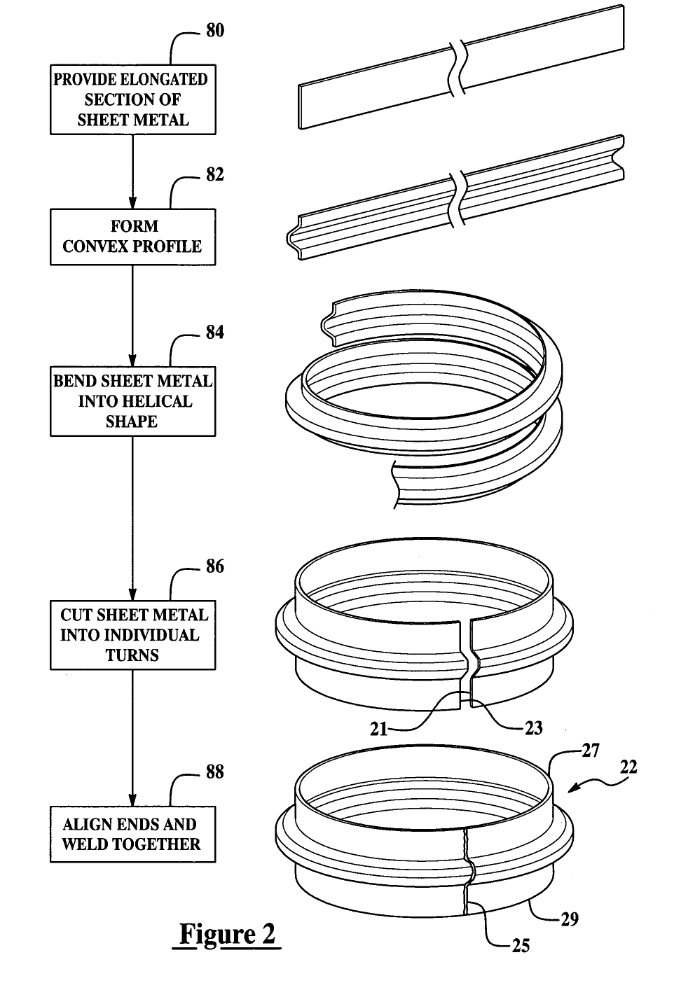

V-insert 32 is connected by welding to inner surface 42, and is shaped to receive first and second flanges 16, 18 when the v-band clamp is installed. V-insert 32 is made out of a suitable steel such as the 301¼ hard stainless steel described earlier. FIG. 2 shows some of the steps involved in making v-ring 22; nonetheless, the first three steps of FIG. 2 are also used for making v-insert 32. The steps need not be performed in the exact order shown or described, and some may be performed simultaneously such as the forming and bending steps. The steel is first provided in an elongated flat strip of sheet metal, step 80. Next, at step 82, the strip is fed into a roll-forming machine and roll-formed between successive pairs of rolls that increasingly form the concave cross-section extending throughout the strip. At step 84, the strip is then bent into a helical shape with a diameter that matches that of band 28 such that a concave surface 50 (FIG. 4) faces radially inwardly along the length of the bend. The remaining steps are not shown in FIG. 2, but are as follows. The strip is cut into individual arcs about every one-third of a turn (e.g., slightly less than 120°). Three such arc segments are then welded to inner surface 42 to form the circumferentially segmented v-insert 32. When complete, the concave surface 50 has slanted annular walls 52, 54 that form an inwardly-facing v-shaped channel. The concave surface generally complements a convex profile of v-ring 22 with annular walls 52, 54 forming an angle that is about 40° to match the angles defined by first and second flanges 16, 18. This process for making v-insert 32 including the roll-forming of the concave profile is conventional and known to those skilled in the art.

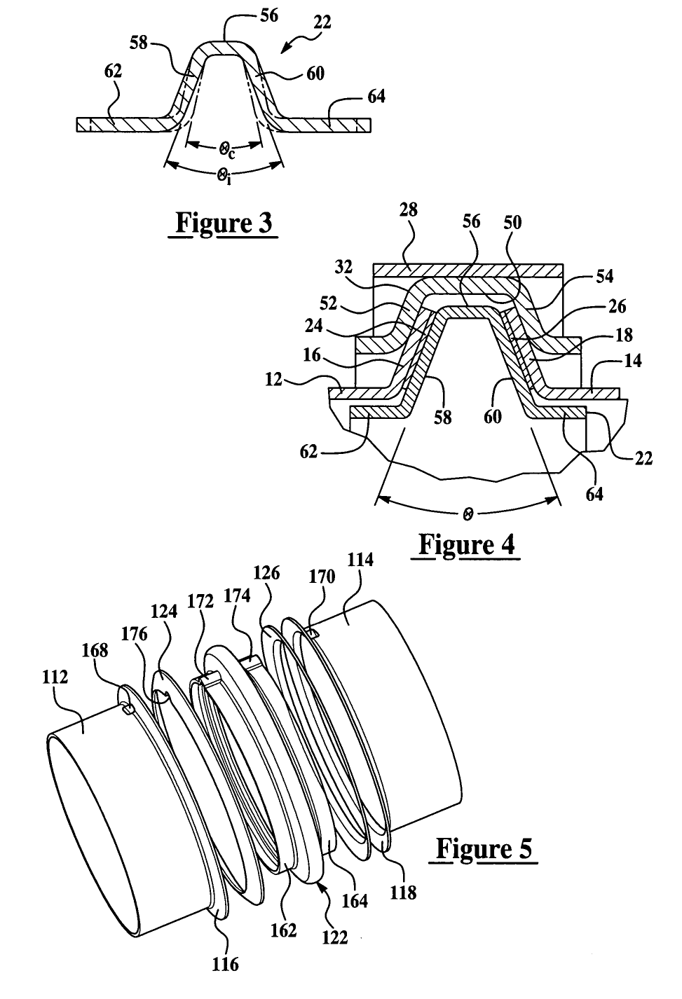

Turning back to FIG. 1, the v-ring component 22 is sized to fit radially within v-band clamp 20 and between pipe ends 12, 14 when pipe clamp assembly 10 is installed. The v-ring enhances the fluid tight seal around the joint. It does so in part by exerting a counter force to the radially inward and axial forces imparted by the tightened v-band clamp on the flanges 16, 18. V-ring 22 has an annular one-piece structure and is formed as a closed loop of sheet metal. Turning now to FIG. 3, v-ring 22 has an outwardly facing convex profile 56 that extends circumferentially around the v-ring. This convex profile is defined primarily by a pair of annular walls 58, 60 slanting away from a flattened central region of the v-ring 22. A pair of pilot sleeves 62, 64 extend axially from annular walls 58, 60 and have a diameter that is less than that of the tubular bodies 12, 14 so that they can telescopically fit into the tubular bodies to help align and retain the components together during assembly. Annular walls 58, 60 are planar in cross-section in such a way that if continued beyond convex profile 56 would define an initial angle θᵢ that is about 43° in the uncompressed state shown in FIG. 3. The figure also shows angle θ_{c} in phantom in a compressed state that is about 40° which matches those angles of first and second flange 16, 18 and annular walls 52, 54 of the v-insert 32.

V-ring 22 is made out of a suitable steel such as 301¼ hard stainless steel, 2 mm thick. FIG. 2 shows the steps involved in making v-ring 22. The steps need not be performed in the exact order shown or described, and some may be performed simultaneously such as the forming and bending steps. At step 80, the steel is first provided in an elongated section of sheet metal in the form of a strip extending from a first end to a second end. Then, the convex profile 56 is formed into the center region of the sheet metal strip (step 82) leaving two side portions that will become the pilot sleeves 62, 64. This can be done by feeding the strip into a roll-forming machine so that it is roll-formed between successive pairs of rolls that increasing form the convex profile through the center of the strip. This profile is preferably (but need not be) formed for the entire length of the sheet metal strip and, when formed, defines an v-shaped channel extending between the first and second ends of the sheet metal. The strip is then bent at step 84 into a helical shape with the v-shaped channel facing radially inwardly along the length of the turns. At step 86, the strip is cut into individual turns each of which has a pair of adjacent ends with the v-shaped channel extending around the turn from one of the adjacent ends to the other adjacent end. These turns have the length equal to the circumference of the completed v-ring 22. Finally, at step 88 the adjacent ends are aligned in a abutting relationship and attached by welding to form the closed annular ring. The outer surface of the v-ring can be ground or filed to provide a smooth, finished surface at the weld. As shown in FIG. 2, the resulting v-ring 22 thus comprises a circular loop of sheet metal having abutting ends 21, 23 that are connected together by a weld 25. This provides v-ring 22 with a continuous convex profile that has a substantially uniform cross-sectional shape about the entire circumference of the v-ring. The weld extends the axial length of the v-ring; that is, it extends from a first axial end 27, along the convex profile 56, to a second axial end 29. As will be appreciated by those skilled in the art, selection of a suitable sheet metal material and thickness provides the v-ring 22 with a compressible feature whereby angle θ can be compressed from 43° to 40° as previously described during tightening of the clamp, and this can be done in a manner that results in temporary deformation of the v-ring so that it springs back towards its original angle when the v-band clamp is loosened.

Turning back to FIG. 1, when the gasket components 24, 26 are seated on v-ring 22, they too enhance the fluid tight seal around the joint. Suitable gaskets are made out of steel to form an annular shape. Each one is disposed on a side of v-ring 22 where they are slanted to sit against annular walls 58, 60. Each gasket has radially-inwardly projecting tangs 66 circumferentially spaced about the gasket. These tangs provide a press-fit when the gaskets are seated on v-ring 22 so that they will not easily slip off during handling. Other than tangs 66, a slight bend (not shown) could be formed along the circumference of gaskets 24, 26 to provide a similar press-fit. As is known in the art, the gaskets can have a curved cross-section so that they provide some resistance to being compressed into the flattened shape shown in FIG. 4 by the clamping forces. This can help improve the fluid tightness of the seal at the gaskets.

To install pipe clamp assembly 10, first pipe end 12 and second pipe end 14 are spaced apart in a concentric and axially aligned relationship. Gasket 24 is press-fit over pilot sleeve 62 until it sits nearly flush against annular wall 58. Gasket 26 is set against annular wall 60 in the same way. V-ring 22, in an uncompressed state and with the pre-attached gaskets 24, 26, is axially aligned with and placed between pipe ends 12, 14. V-band clamp 20, in a loosened state, is positioned over one pipe end beyond the respective flange such that it rests around the respective pipe end wall. Turning now to FIG. 4, first pipe end 12 and second pipe end 14 are brought together in a still axially aligned direction radially over and circumferentially around v-ring 22. First flange 16 and second flange 18 are brought into respective contact with gaskets 24, 26; while the very ends of bottom surfaces of first pipe end 12 and second pipe end 14 respectively lay over pilot sleeves 62, 64. At this point, v-ring 22 is still in a somewhat uncompressed state with an angle θ of about 43° and hence the flanges are not completely flush against gaskets 24, 26. The loose v-band clamp 20 is then positioned circumferentially around that partial joint. Concave surface 50 is pressed over convex profile 56 with flanges 16, 18 and gaskets 24, 26 captured therebetween. Annular walls 52, 54 press against flanges 16, 18 on a side of the flanges opposite the gaskets.

V-band clamp 20 is then tightened to clamp pipe clamp assembly 10 and form a final joint between first pipe end 12 and second pipe end 14. Tightening mechanism 30 is used to bring first and second ends 34, 36 toward each other by threading nut 48 onto T-bolt 46. As tightening commences, the ends impart a radially inward force circumferentially around the joint through v-insert 32, which in turn imparts that force to flanges 16, 18 and against v-ring 22. The v-ring is compressed such that angle θ is forced from the 43° angle and towards the 40° angle that matches the slanted angle of the flanges and the concave surface angle. Once fully tightened, a counter force remains exerted outwardly from v-ring 22 against flanges 16, 18 and in turn against v-insert 32. To uninstall pipe clamp assembly 10, tightening mechanism 30 is loosened, v-clamp 20 is pulled away from the now partial joint, and first pipe end 12 and second pipe end 14 are pulled apart.

### Second Embodiment

FIG. 5 shows a second embodiment of a pipe clamp assembly. Elements of this embodiment that correspond to similar elements of the first embodiment in FIG. 1 are identified with numerals offset by 100 from those used in that embodiment. The v-band clamp is not depicted in this FIG. 5; however, the v-band clamp and its parts including the band, tightening mechanism, and v-insert, are the same in this embodiment as they were described in the first embodiment so their description is omitted here.

A first pipe end 112 and a second pipe end 114 include a first flange 116, a second flange 118, a first indexing feature 168, and a second indexing feature 170. The pipe ends and flanges are similar to those described in the previous embodiment. The indexing features mate with corresponding indexing features found on v-ring 122 for circumferentially and axially aligning the v-ring with the pipe ends during installation. The first indexing feature 168 is formed in the edge of first pipe end 112 as a recess by a suitable forming process. The second indexing feature 170 is formed the same way as a recess in second pipe end 114. Both recesses extend through flanges 116, 118.

V-ring 122 is similar to the v-ring described in the previous embodiment. One difference is that v-ring 122 has a first indexing feature 172 and a second indexing feature 174. First indexing feature 172 is formed as a protuberance on a pilot sleeve 162 and extends to the annular wall that forms the convex profile. Protuberance 172 is made by a suitable forming process performed after forming the convex profile. Second indexing feature 174 is formed as a protuberance the same way in a pilot sleeve 164. These protuberances 172, 174 correspond with the pipe end recesses 168, 170 and are sized to fit within the recesses in a mating relationship. This indexing arrangement allows the v-ring to be used to achieve a predetermined alignment between the two pipe ends 112, 114.

A pair of gaskets 124, 126 are provided which are similar to those gaskets described in the previous embodiment. One difference is that the tangs in the previous embodiment are omitted. Another difference is that each gasket has an indexing feature in the form of a recess (recess 176 in gasket 124, not shown in gasket 126). The recess is formed on the inside edge of each gasket 124, 126 and complements the shape of protuberances 172, 174 in another mating relationship. This allows the gasket to be angularly oriented relative to the v-ring which can be useful for serviceability since once the gasket is initially clamped, it can deform and take on the shape of any imperfections on the v-ring surface. This means that, if the joint is ever serviced and the gaskets removed from the v-ring, reattachment of the gaskets should be done using the same angular orientation that it originally had so that it will achieve its best fit and reduce the likelihood of leakage along the gasket. The use of the gasket and v-ring indexing features helps insure that this angularly orientation is maintained.

These parts are installed similarly as in the previous embodiment except that gaskets 124, 126 are fitted over pilot sleeves 162, 164 such that recess 176 and the other recess are aligned with protuberances 172, 174. The recesses sit over the protuberances and prevent the gaskets from rotating in the circumferential direction. Then, as first pipe end 112 and second pipe end 114 are brought together, recesses 168, 170 are aligned with protuberances 172, 174 so that the recesses receive the protuberances and thereafter prevent relative rotation. This same indexing task is possible if the pipe end indexing features are protuberances, and the v-ring indexing features are recesses (in that case, if gaskets are used, the gasket recesses could also be implemented as a protuberance).

### Third Embodiment

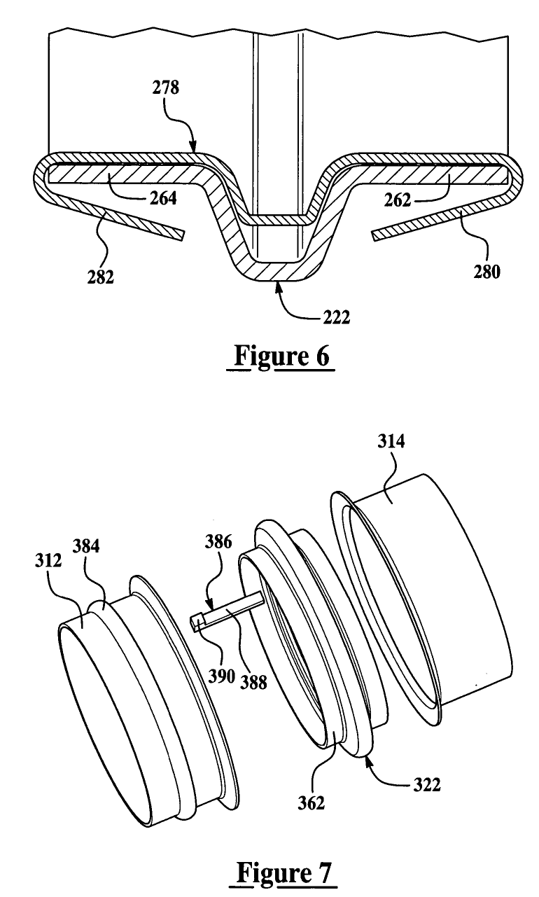

FIG. 6 shows a third embodiment of a pipe clamp assembly. Elements of this embodiment that correspond to similar elements of the first embodiment in FIG. 1 are identified with numerals offset by 200 from those used in that embodiment. The figure omits the v-band clamp and the gaskets. However, these components and their parts are the same in this embodiment as they were described in the first embodiment so their description is omitted here.

FIG. 6 depicts the v-ring 222 which can be identical to v-ring 22 of FIG. 1. However, in this embodiment, the v-ring 222 is fitted with a clip 278 for pre-attaching v-ring 222 to the pipe ends as a part of the assembly process. Clip 278 is bent out of a suitable metal to a shape corresponding to the cross-sectional shape of v-ring 222. A pair of clips 278 are attached as shown about 180° apart on v-ring 222. Clip 278 has a body that wraps around the v-ring with extending flex arms 280, 282. In particular, the clip extends along the inner surface of the v-ring and can, but need not, partially (or fully) extend into the v-shaped channel defined by the convex profile of the v-ring. The clip wraps around the axial ends of the v-ring and such that they are bent around pilot sleeves 262, 264 and remain suspended over them. When the pipe ends are brought together, flex arms 280, 282 are squeezed towards pilot sleeves 262, 264 and lie under respective pipe ends. When squeezed, each flex arm exerts a radially outward force that wedges v-ring 222 under the pipe ends. These clips allow pre-attachment of the v-ring and pipe ends together which can help simplify the clamp assembly process.

### Fourth Embodiment

FIG. 7 shows a fourth embodiment of a pipe clamp assembly. Elements of this embodiment that correspond to similar elements of the first embodiment in FIG. 1 are identified with numerals offset by 300 from those used in that embodiment. The figure shows a v-ring 322 without the v-band clamp or gaskets. The gaskets and v-band clamp and its parts including the band, tightening mechanism, and v-insert, are the same in this embodiment as they were described in the first embodiment so their description is omitted here.

First pipe end 312 is similar to the first pipe end of the first embodiment. One difference is that first pipe end 312 has a pre-attachment feature 384 in the form of circumferential retention bead. As will be described below, retention bead 384 cooperates and mates with a distal end portion of a clip 386 attached to v-ring 322 for pre-attaching the v-ring to at least one of the pipe ends.

V-ring 322 is similar to the v-ring of the first embodiment. One difference is that v-ring 322 has a pre-attachment feature 386 in the form of a staging clip. Staging clip 386 is made of a suitable metal and is an elongated component that extends from a proximal end to a distal end, with the clip being attached by welding the proximal end to the v-ring at the inner surface of pilot sleeve 362. It has a flex arm 388 extending axially from the v-ring to the distal end where it includes a radially-projecting boss 390. When pipe ends 312, 314 are brought together, flex arm 388 guides staging clip 386 below first pipe end 312 until boss 390 snaps into retention bead 384. Boss 390 is mated and trapped in the space provided by retention bead 384, and in this way v-ring 322 is prevented from axially pulling away from first pipe end 312. A similar clip can be used to pre-attach the other pipe end 314. Alternatively, the clip 378 can be double-ended; that is, it can extend all the way through the v-ring 322 and out the other axial end with a second projecting boss to mate with a retention bead in the other pipe end 314.

### Fifth Embodiment

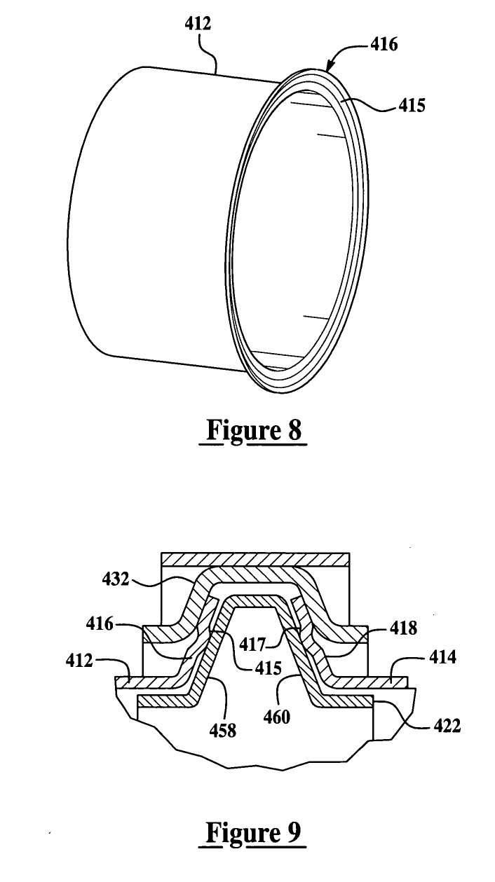

FIGS. 8 and 9 shows a fifth embodiment of a pipe clamp assembly. Elements of this embodiment that correspond to similar elements of the first embodiment in FIG. 1 are identified with numerals offset by 400 from those used in that embodiment. The v-band clamp and v-ring insert can be the same as that of the first embodiment and so their description is omitted here. In this embodiment, the gaskets have been eliminated and their function replaced by a circumferentially-extending bead 415, 417 formed on the respective end flanges 416, 418 of the pipe ends. Each bead 415, 417 projects axially away from its associated pipe end such that, during assembly, bead 415 engages the annular wall 458 of the v-ring 422, and bead 417 engages annular wall 460. During tightening of the clamp, the annular walls of the v-insert 432 engage the flanges 416, 418 on the outer side of these flanges, that is, on the side of the flanges opposite the beads 415, 417, and tightening of the clamp provides a mostly axial force on the flanges which compresses the beads 415, 417 against the annular walls 458, 460 of the v-ring 422 to thereby provide a gas-tight seal of the flanges to the v-ring without the use of gaskets.

Although the v-insert 432 is shown as not completely overlying the beads 415, 417, it will be appreciated that the relative positions and dimensions of the beads and annular walls of the v-insert could be selected as desired so that the v-insert fully covers the beads either at the point of initial assembly of the components together, or as the result of the clamp being fully tightened.

It is to be understood that the foregoing description is not a description of the invention itself, but of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, although the illustrated v-band clamps utilize a segmented v-insert and separate outer band, the v-band clamp can be implemented using a single piece of circumferentially-extending sheet metal formed to have inwardly-slanted annular walls that define the v-shaped channel without using a separate outer flat band. A suitable tightening mechanism would then be attached to the adjacent ends of this v-shaped band. Also, in some embodiments of the sheet metal v-ring, it may not be necessary for a particular application that the weld extend the entire axial length of the v-ring, rather for example, space spot welds could be used or a weld seam that only extends partly between the axial ends. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A pipe clamp assembly for joining a pair of tubular body ends each having a flange, comprising:
a v-band clamp having a roundish shape that extends from a first end to a second end, said v-band clamp having a first pair of annular walls forming an inwardly-facing v-shaped channel that extends at least partially between said first and second ends, said v-band clamp further including a tightening mechanism connected to said first and second ends to draws said ends toward and away from each other to tighten and loosen said v-band clamp; and
a v-ring comprising a circular loop of sheet metal having an outer surface that includes an outwardly-facing convex profile formed into the sheet metal and being sized to fit at least partially within said channel, said circular loop of sheet metal having first and second abutting ends with said convex profile extending circumferentially around said v-ring from said first abutting end to said second abutting end, wherein said abutting ends are connected together by a weld that extends from a first axial end of said v-ring insert, along said convex profile, to a second axial end of said v-ring.

2. A pipe clamp assembly as defined in claim 1, wherein said v-band clamp further comprises:
a band having a roundish shape that extends from said first end to said second end, said band having an inner surface that faces radially inwardly; and
a v-insert connected to said inner surface of said band, said v-insert including said first pair of annular walls.

3. A pipe clamp assembly as defined in claim 2, wherein said v-insert comprises a plurality of arc segments of sheet metal each having said first pair of annular walls and being attached at spaced circumferential locations to the inner surface of said band.

4. A pipe clamp assembly as defined in claim 1, wherein said convex profile is defined at least in part by a second pair of annular walls that extend circumferentially from said first abutting end to said second abutting end.

5. A pipe clamp assembly as defined in claim 4, further comprising a pair of gaskets each sized to engage one of said second pair of annular walls, wherein said v-ring includes a pilot sleeve axially extending from each of said second pair of annular walls, and wherein said gaskets include a plurality of radially inwardly extending tangs that contact said outer surface of said v-ring at said pilot sleeves to thereby provide a press-fit connection of said gaskets to said v-ring.

6. A pipe clamp assembly as defined in claim 4, wherein said v-ring includes a pilot sleeve axially extending from each of said second pair of annular walls, and wherein said pilot sleeves include an indexing feature located at one or more angular locations about the circumference of said v-ring, whereby said indexing feature can mate with corresponding indexing features in the tubular body ends to thereby rotationally align the tubular body ends to each other during assembly of said v-ring and v-band clamp to the tubular body ends.

7. A pipe clamp assembly as defined in claim 4, wherein said first pair of annular walls are slanted and define a first angle therebetween and said second pair of annular walls are slanted and define a second angle therebetween, with said second angle being greater than said first angle.

8. A pipe clamp assembly as defined in claim 7, wherein said sheet metal of said v-ring is deformable during tightening of said tightening mechanism such that the measure of said second angle decreases toward the measure of said first angle.

9. A pipe clamp assembly as defined in claim 4, further comprising a pair of gaskets that mate with said second pair of annular walls, wherein said v-ring and gaskets include an indexing feature that allows said gaskets to be angularly aligned with said v-ring.

10. A pipe clamp assembly as defined in claim 1, further comprising a clip attached to said v-ring, wherein said clip is adapted to engage an inner surface of at least one of the tubular body ends to enable pre-attachment of the v-ring to at least one of the tubular body ends.

11. A pipe clamp assembly as defined in claim 10, wherein said v-ring has a pair of pilot sleeves that extend axially from said convex profile, and wherein said clip extends axially along an inner surface of said v-ring and wraps around both said first and second axial ends of said v-ring onto said outer surface and extends over at least a portion of said pilot sleeves.

12. A pipe clamp assembly as defined in claim 10, wherein said clip has a proximal end and a distal end with said proximal end being connected to said v-ring, and wherein said clip extends axially from said first axial end of said v-ring, said clip having a retention feature on its distal end which mates with a corresponding feature of one of the tubular body ends to thereby enable the pre-attachment of said v-ring.

13. A pipe clamp assembly for joining a pair of tubular body ends each having a flange, comprising:
a v-band clamp having a roundish shape that extends from a first end to a second end, said v-band clamp having a first pair of annular walls forming an inwardly-facing v-shaped channel and defining a first angle between said walls, said v-band clamp further including a tightening mechanism connected to said first and second ends to draws said ends toward and away from each other to tighten and loosen said v-band clamp; and
a v-ring having a second pair of annular walls that form an outwardly-facing convex profile on an outer surface of said v-ring, said convex profile being sized to fit at least partially within said channel with said second pair of annular walls defining a second angle that is greater than said first angle.

14. A pipe clamp assembly as defined in claim 13, wherein said v-band clamp further comprises:
a band having a roundish shape that extends from said first end to said second end, said band having an inner surface that faces radially inwardly; and
a v-insert connected to said inner surface of said band, said v-insert including said first pair of annular walls.

15. A pipe clamp assembly as defined in claim 14, wherein said v-insert comprises a plurality of arc segments of sheet metal each having said first pair of annular walls and being attached at spaced circumferential locations to the inner surface of said band.

16. A pipe clamp assembly as defined in claim 13, further comprising a pair of gaskets press-fitted on opposite sides of said v-ring.

17. A pipe clamp assembly as defined in claim 13, further comprising a pair of gaskets that mate with said second pair of annular walls, wherein said v-ring and gaskets include an indexing feature that allows said gaskets to be angularly aligned with said v-ring.

18. A pipe clamp assembly as defined in claim 13, wherein said v-ring includes a pilot sleeve axially extending from each of said second pair of annular walls, and wherein said pilot sleeves include an indexing feature located at one or more angular locations about the circumference of said v-ring, whereby said indexing feature can mate with corresponding indexing features in the tubular body ends to thereby rotationally align the tubular body ends to each other during assembly of said v-ring and v-band clamp to the tubular body ends.

19. A pipe clamp assembly as defined in claim 13, wherein said v-ring comprises a circular loop of sheet metal having first and second abutting ends with said convex profile extending circumferentially around said v-ring from said first abutting end to said second abutting end, wherein said abutting ends are connected together by a weld that extends from a first axial end of said v-ring, along said convex profile, to a second axial end of said v-ring.

20. A pipe clamp assembly as defined in claim 19, wherein said sheet metal of said v-ring is deformable during tightening of said tightening mechanism such that the measure of said second angle decreases toward the measure of said first angle.

21. A pipe clamp assembly as defined in claim 13, wherein said second angle is about 3° greater than said first angle.

22. A pipe clamp assembly as defined in claim 13, further comprising a clip attached to said v-ring, wherein said clip is adapted to engage an inner surface of at least one of the tubular body ends to enable pre-attachment of the v-ring to at least one of the tubular body ends.

23. A pipe clamp assembly as defined in claim 22, wherein said v-ring has a pair of pilot sleeves that extend axially from said convex profile, and wherein said clip extends axially along an inner surface of said v-ring and wraps around first and second axial ends of said v-ring and onto said outer surface and extends over at least a portion of said pilot sleeves.

24. A pipe clamp assembly as defined in claim 22, wherein said clip has a proximal end and a distal end with said proximal end being connected to said v-ring, and wherein said clip extends axially from said v-ring, said clip having a retention feature on its distal end which mates with a corresponding feature of one of the tubular body ends to thereby enable the pre-attachment of said v-ring.

25. A pipe clamp assembly for joining a pair of tubular body ends each having a flange, comprising:
a v-band clamp having a roundish shape that extends from a first end to a second end, said v-band clamp having a first pair of annular walls forming an inwardly-facing v-shaped channel that extends at least partially between said first and second ends, said v-band clamp further including a tightening mechanism connected to said first and second ends to draws said ends toward and away from each other to tighten and loosen said v-band clamp; and
a v-ring comprising a circular loop of metal having a radially outwardly convex profile extending about the circumference of the circular loop, said convex profile being located between a pair of pilot sleeves that each extend from said convex profile to an axial end of said v-ring, said v-ring including an indexing feature formed in said pilot sleeves at an angular location about the circumference of said v-ring.

26. A pipe clamp assembly as defined in claim 25, further comprising a pair of gaskets that fit over said pilot sleeves, wherein said gaskets include an indexing feature that allows said gaskets to be angularly aligned with said v-ring using the indexing feature of said v-ring.

27. A pipe clamp assembly for joining a pair of tubular body ends each having a flange, comprising:
a v-band clamp having a roundish shape that extends from a first end to a second end, said v-band clamp having a first pair of annular walls forming an inwardly-facing v-shaped channel that extends at least partially between said first and second ends, said v-band clamp further including a tightening mechanism connected to said first and second ends to draws said ends toward and away from each other to tighten and loosen said v-band clamp; and
a v-ring comprising a circular loop of metal having an outer surface that includes an outwardly-facing convex profile that is sized to fit at least partially within said channel; and
a clip attached to said v-ring, wherein said clip is adapted to engage an inner surface of at least one of the tubular body ends to enable pre-attachment of the v-ring to at least one of the tubular body ends.

28. A pipe clamp assembly as defined in claim 27, wherein said v-ring has a pair of pilot sleeves that extend axially from said convex profile, and wherein said clip extends axially along an inner surface of said v-ring and wraps around first and second axial ends of said v-ring and onto said outer surface and extends over at least a portion of said pilot sleeves.

29. A pipe clamp assembly as defined in claim 27, wherein said clip has a proximal end and a distal end with said proximal end being connected to said v-ring, and wherein said clip extends axially from said v-ring, said clip having a retention feature on its distal end which mates with a corresponding feature of one of the tubular body ends to thereby enable the pre-attachment of said v-ring.

30. A pipe clamp and tubular body end assembly, comprising:
first and second tubular bodies each having a radially projecting flange positioned at an end of said tubular body;
a v-band clamp having a roundish shape that extends from a first end to a second end, said v-band clamp having a first pair of annular walls forming an inwardly-facing v-shaped channel that extends at least partially between said first and second ends, said v-band clamp further including a tightening mechanism connected to said first and second ends to draws said ends toward and away from each other to tighten and loosen said v-band clamp; and
a v-ring comprising a circular loop of metal having an outer surface that includes an outwardly-facing convex profile defined at least in part by a second pair of annular walls;
wherein said flanges each have a circumferentially-extending bead that projects axially away from said tubular body, wherein each of said flanges of said tubular bodies engage one of said second pair of annular walls via said bead, with said first pair of annular walls engaging said flanges on a side of said flanges opposite said bead, and wherein, during tightening of said v-band clamp, said first pair of annular walls axially force said flanges toward each other and compress said beads against said second pair of annular walls to thereby provide a gas-tight seal of said flanges to said v-ring.
